(19) United States
(12) Patent Application Publication
(10) Pub. No.: US 2013/0132103 A1
(43) Pub. Date: May 23, 2013

(54) Quick-Fill

(71) Applicant: Mark J. Wilson, Albuquerque, NM (US)

(72) Inventor: Mark J. Wilson, Albuquerque, NM (US)

(21) Appl. No.: 12/930,912

(22) Filed: Jan. 20, 2011

(51) Int. Cl. G06Q 50/22

(52) U.S. Cl. CPC G06Q 50/22; G06Q 10/06314
USPC 705/2

(57) ABSTRACT

‘Quick-Fill’ is a process, pathway, or means whereby appointment failures of other short-notice opportunities may be directed to desired parties via modern communication media/social networking.

A process/pathway whereby short notice schedule/appointment book cancellations, inventory, or other opportunities or failures are uploaded and selected/premier/or general groups notified. This may involve current appointment book notification processes such as ‘Televox’ or social media tools such as ‘Facebook’, ‘Twitter’, ‘Groupon, etc. . . . A message, possibly with a discount opportunity, will be sent to patients/clients or other entities to immediately ‘Quick-Fill’ a recent opening, failure, or opportunity.

1. Software, pathways, and methodologies to quickly notify patients or other entities of short-notice appointment book failures, unsold events, inventory, or other opportunities by quickly uploading and transmitting such opportunities via modern cell-phone, social media, ‘cloud’ technologies or similar such, thereby creating a new opportunity to ‘Quick-Fill’ such openings.
